(19) United States
(12) Patent Application Publication
(10) Pub. No.: US 2006/0265013 A1
(43) Pub. Date: Nov. 23, 2006

(54) Baby pacifier with telescoping cap

(75) Inventor: James W. Holley JR., Colorado Springs, CO (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Insta-mix, Inc., Subsidiary A (DBA UMIX, Inc.), Colorado Springs, CO (US)

(21) Appl. No.: 11/131,650

(22) Filed: May 17, 2005

(51) Int. Cl. A61J 17/00

(52) U.S. Cl. 606/234

(57) ABSTRACT

A baby pacifier includes a substantially flat base, a nipple extending from a front surface of the base, and a telescoping cap that alternatively attaches in an expanded configuration to the front surface of the pacifier base over the nipple when the pacifier is not in use, and to a rear surface of the pacifier base in a collapsed configuration while the pacifier is in use. The telescoping cap is formed by two interconnecting pieces that slide relative to each other between the collapsed and expanded configurations. Alternatively, the telescoping cap includes a folding, accordion-like side wall.

### FIELD OF THE INVENTION

The present invention is related generally to an improved baby pacifier, and more particularly to a baby pacifier having a cover that attaches to the nipple/base when the baby pacifier is either in use or not in use.

### BACKGROUND OF THE INVENTION

Through the years a number of pacifier devices have been developed for use in providing a soothing member for use by a human infant. While the specific structure of baby pacifiers developed have taken many forms, all may generally be said to include an elongated soft resilient nipple member generally terminating in a bulbous end which is sized and adapted to be received within the infant's mouth. The soothing action arises from the nursing or sucking action of the infant upon this extended resilient member. For purposes of safety, such pacifiers also generally include a rather enlarged, planar base member at the remote end of the resilient member which is of sufficient size to be too large for the infant to draw into its mouth. In most structures, the side of the planar base member supports a handle of some sort configured to be readily grasped by an infant's hand.

During normal use, baby pacifiers are moistened by the infant, and repeatedly removed from the infant's mouth and returned for continued pacification. In many instances, those caring for infants will need to remove the pacifier from the infants use for some prolonged period of time. During these periods of nonuse, it is often difficult to readily carry, transport or store the pacifier due to the moisture applied to the pacifier by the infant's mouth. In addition, it is desirable to maintain or store the pacifier in a manner that avoids subjecting it to dirt, germs or other contaminants. In the typical environment in which such pacifiers are used, this maintenance of sanitation and cleanliness is often difficult to achieve.

These problems have caused practitioners in the art to develop various pacifiers which provide some improved cleanliness and transportability. A basic approach is to provide a cover (cap) that mounts over the nipple and secures to the pacifier base while not in use. One such cover is disclosed in U.S. Pat. No. 4,946,054 to Maniero et al. A problem with such covers is that they are separated from the pacifier while not in use, and therefore often become misplaced, thereby resulting in continued exposure of the pacifier nipple during periods of nonuse. Another approach disclosed in U.S. Pat. No. 5,578,058 provides a bivalve shell that closes over the nipple when not in use, and folds back to expose the nipple when in use. A problem with these bivalve covers is that they can be partially or completely closed by a baby while the pacifier is in use, thereby causing frustration and potential injury.

What is needed is an improved and effectively baby pacifier in which the cap/cover remains secured to the pacifier base during use in a way that is not easily manipulated by the baby, thereby avoiding unwanted interruption due to manipulation of the cap/cover by the baby during use, and making the cover readily available to cover the nipple during non-use.

### SUMMARY OF THE INVENTION

The present invention is directed to a baby pacifier including a telescoping cap (cover) that expands to mount over the pacifier nipple when the pacifier is not in use, and collapses and attaches to a rear side of the pacifier base when the pacifier is in use. By providing the telescoping cap with the ability to adjust between these expanded and collapsed configurations, the present invention provides a reliable method for preventing loss of the cap by allowing the cap to remain securely connected to base whether pacifier is in use or not in use. Further, because cap is securely attached in the collapsed configuration to rear surface of base during use, a baby is provided unimpeded access to nipple, and unintended removal by the baby is prevented.

In accordance with an embodiment of the present invention, an improved baby pacifier includes a substantially flat base having opposing front and rear surfaces, an elongated nipple extending from the front surface, and a two-part telescoping cap that alternatively attaches in an expanded configuration to the front side of the pacifier base when not in use, and in a collapsed configuration to the rear side of the pacifier base when in use. The two-part telescoping cap includes a conical member having openings at both ends, and a hat-shaped member that slidably fits inside the conical member. A front attaching structure (e.g., a disk-shaped protrusion) is provided on the front side of the base, and the conical member press-fits onto the front attaching structure in the expanded configuration. A rear attaching structure in the form of a threaded, disk-like protrusion is provided on the rear surface of the pacifier base, and the hat-shaped member includes a threaded connecting feature that is screw-fitted onto the rear attaching structure when the pacifier is not in use. The front attaching structure is provided with radial grooves that permit air-flow at the base of the nipple to prevent chapping.

### BRIEF DESCRIPTION OF THE DRAWINGS

These and other features, aspects and advantages of the present invention will become better understood with regard to the following description, appended claims, and accompanying drawings, where:

FIG. 1 is an exploded perspective view showing a baby pacifier according to an embodiment of the present invention;

FIG. 2 is a rear plan view showing a base of the pacifier of FIG. 1;

FIGS. 3(A), 3(B) and 3(C) are cross-sectional side views showing a telescoping cap of the pacifier of FIG. 1 in various configurations;

FIG. 4 is a simplified cross-sectional side view showing the telescoping cap in the expanded configuration of FIG. 3(A) mounted onto a front attachment structure provided on the pacifier base;

FIG. 5 is a simplified cross-sectional side view showing the telescoping cap in the collapsed configuration of FIG. 3(C) mounted onto a rear attachment structure provided on the pacifier base;

FIGS. 6(A) and 6(B) are cross-sectional side views showing a telescoping cap according to another embodiment of the present invention;

FIG. 7 is a simplified cross-sectional side view showing the telescoping cap of FIGS. 6(A) and 6(B) mounted over the nipple of a baby pacifier;

FIG. 8 is a simplified cross-sectional side view showing the telescoping cap of FIGS. 6(A) and 6(B) mounted onto a rear side of a baby pacifier;

FIG. 9 is an exploded perspective view showing a pacifier according to another embodiment of the present invention;

FIG. 10 is a side view showing the pacifier of FIG. 9 in an assembled state;

FIG. 11 is an exploded perspective view showing a telescoping cap according to another embodiment of the present invention; and

FIG. 12 is a side view showing the telescoping cap of FIG. 11 mounted onto the pacifier of FIG. 9.

### DETAILED DESCRIPTION OF THE DRAWINGS

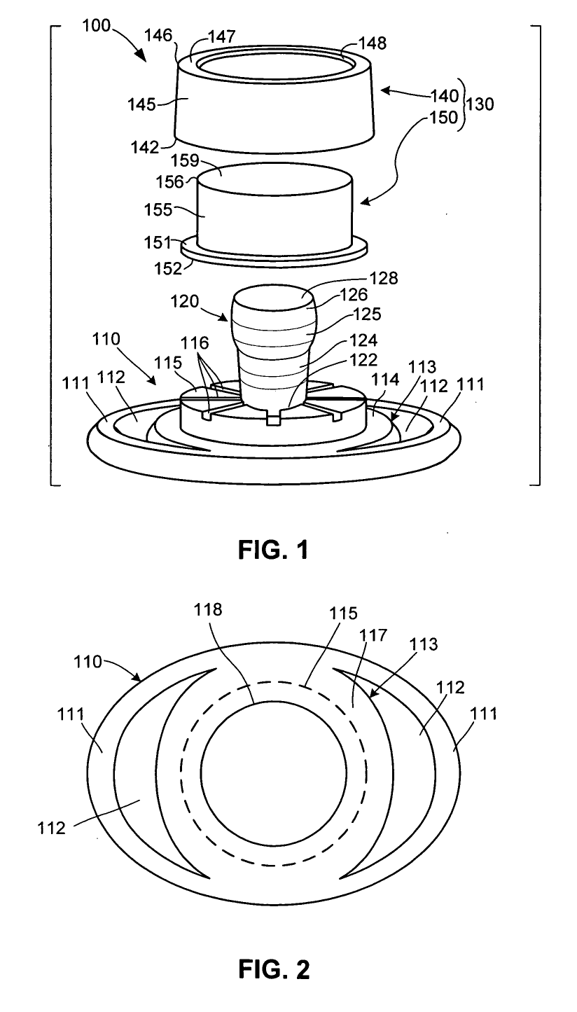

FIG. 1 is an exploded perspective view showing a baby pacifier 100 according to an exemplary embodiment of the present invention. Baby pacifier 100 generally includes a substantially flat base 110 having a front (first) surface 114 and an opposing rear (second) surface 117, an elongated nipple 120 extending from first surface 114, and a two-part telescoping cap 130 that, as described in additional detail below, is alternatively connected in an expanded configuration on first surface 114 over nipple 120 (indicated in FIG. 4), or in a collapsed configuration on second surface 117 (indicated in FIG. 5). By providing telescoping cap 130 with the ability to adjust between these expanded and collapsed configurations, the present invention provides a reliable method for preventing loss of cap 130 by allowing cap 130 to remain connected to base 110 whether pacifier 100 is in use or not in use. Further, because cap 130 is attached in the collapsed configuration to rear surface 117 of base 110 during use, a baby is provided unimpeded access to nipple 120.

Base 110 is formed from a relatively rigid plastic using known plastic molding techniques. Base 110 includes side handles 111 that extend from peripheral side edges of a central member 113 such that finger openings 112 are defined therebetween. Extending from front surface 114 is a front (first) attaching structure 115 that, in the present embodiment, is in the form of a flat cylindrical (disk-shaped) protrusion. Nipple 120 extends through a central opening formed in front attaching structure 115, and a series of radial grooves 116 are formed in an upper surface of front attaching structure 115. As indicated in FIG. 1, grooves 116 extend radially from the center of front attaching structure 115 to facilitate air flow to base section 124 of nipple 120 during use in order to prevent chapping. As indicated in FIG. 2, a rear (second) attaching structure 118 is formed on a rear surface 117 of central member 113. Similar to front attaching structure 115, rear attaching structure 118 generally comprises a disk-shaped protrusion that extends from rear surface 117, but as indicated in FIG. 2 has a smaller diameter than front attaching structure 115. In addition, as discussed below, rear attaching structure 118 includes threads that facilitate connection to telescoping cap 130.

Referring again to FIG. 1, nipple 120 is formed from a relatively soft material (e.g., silicone) using known fabrication techniques. Nipple 120 includes a fixed end 122 that is fixedly connected to base member 110, relatively narrow base section 124 that extends through front attaching structure 115, a relatively wide section 125 extending from base section 124, and a free end 126. In the present embodiment, nipple 120 has a substantially flat end 128 that is substantially parallel to base 110. In an alternative embodiment, nipple 120 may have a rounded end that is similar to conventional nipples.

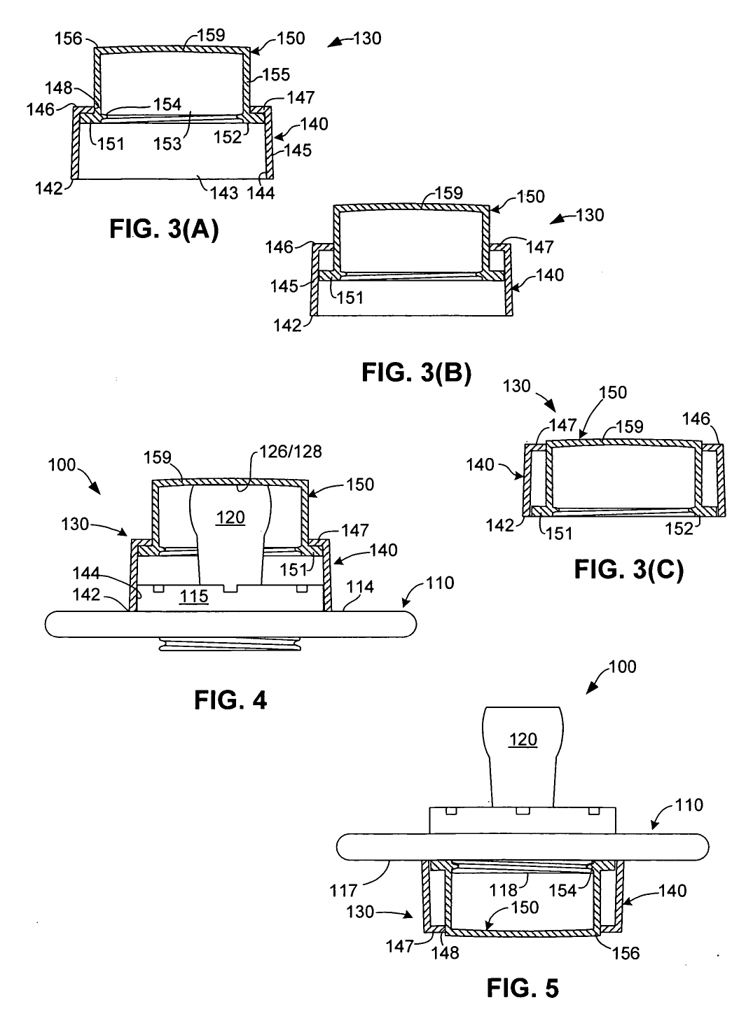

Referring to the upper portion of FIG. 1 and to FIG. 3(A), telescoping cap 130 includes a conical (first) member 140 and a hat- or bowl-shaped (second) member 150 that is slidably received inside conical member 140, both molded from a rigid plastic that, in one embodiment, is transparent. Conical member 140 has a relatively wide (first) end 142 defining a first opening 143, a peripheral wall 145, and a relatively narrow (second) end 146 including a collar 147 defining a second opening 148. In the present embodiment, an inside surface of peripheral wall 145 that is adjacent to first opening 143 forms a (first) attachment feature 144 that is used to secure telescoping cap 130 to front attaching structure 115 in the manner described below. Hat-shaped member 150 includes a disk-like flange 151 located at a lower (first) end 152 that defines a first opening 153, a peripheral wall 155, and an upper (second) end 156 that is closed by a cover plate 159. In the present embodiment, an inside surface of peripheral wall 155 that is adjacent to first opening 153 includes a threaded structure that forms a (second) attachment feature 154 used to secure telescoping cap 130 to rear attaching structure 118 in the manner described below. When assembled as shown in FIG. 3(A), lower end 142 and opening 143 form an open end of telescoping cap 130, and upper end 156 and cover plate 159 form a closed end of telescoping cap 130.

FIGS. 3(A) to 3(C) show telescoping cap 130 during transition between an expanded configuration (FIG. 3(A)) that facilitates mounting over nipple 120 when pacifier 100 is not in use (as illustrated in FIG. 4), and a collapsed configuration (FIG. 3(C)) that facilitates convenient attachment to the rear side of pacifier 100 during use (as illustrated in FIG. 5).

Referring to FIG. 3(A) and FIG. 5, in the expanded configuration, hat-shaped member 150 is fully inserted through second opening 148 of conical member 140 such that flange 151 abuts a lower surface of collar 147, thereby preventing separation of hat-shaped member 140 from conical member 150, and facilitating the connection of telescoping cap 130 to base 110 by way of front attachment structure 115 and attaching feature 144. In the present embodiment, as indicated in FIG. 4, attaching feature 144 comprises the inside surface of peripheral wall 145, which is sized such that a tight press-fit connection is formed between conical member 140 and front attachment structure 115. In an alternative embodiment, both front attachment structure 115 and the inside surface of peripheral wall 145 may be provided with matching threads that facilitates screw-connection of telescoping cap 130 to base 110. Note that members 140 and 150 are constructed such that their combined height facilitates enclosure of nipple 120. In this way, telescoping cap 130 protects nipple 120 from contamination when pacifier 100 is not in use.

Referring to FIG. 3(B), when telescoping cap 130 is subsequently separated from base 110 in preparation for use, hat-shaped member 150 is slid relative to conical member 140 such that telescoping cap 130 is collapsed.

Referring to FIG. 3(C), in the fully collapsed configuration, first end 142 of conical member 140 is located adjacent to flange 151/end 152 of hat-shaped member 150, and collar 147 is substantially aligned with cover plate 159. In this configuration, as indicated in FIG. 5, attaching feature 154 is screw-connected to rear attaching structure 118, thereby facilitating the convenient connection of telescoping cap 130 to base 110 during the use of pacifier 100 (i.e., such that nipple 120 is fully exposed). Note that a diameter of opening 148 is slightly smaller than a diameter of end 156, thereby preventing conical member 140 from sliding off of hat-shaped member 150 when in the collapsed position.

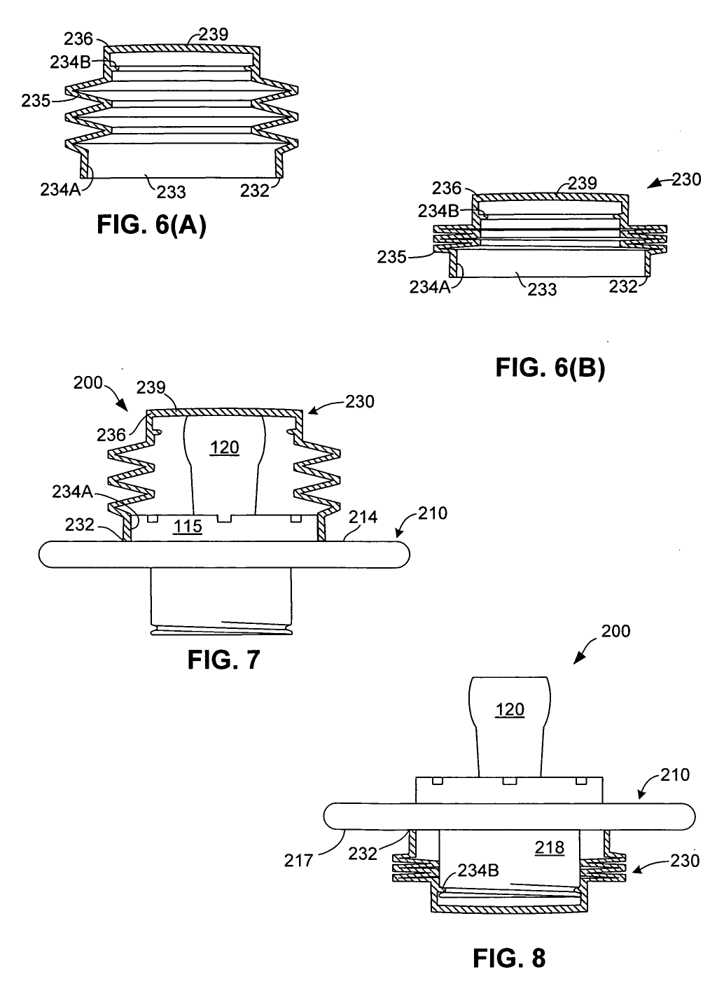

FIGS. 6(A) and 6(B) are cross-sectional side views showing a telescoping cap 230 according to another embodiment of the present invention. FIGS. 7 and 8 are simplified cross-sectional side views showing telescoping cap 230 mounted onto a baby pacifier 200. In these figures, structures of pacifier 200 that are substantially identical to those described above with reference to pacifier 100 are identified with like reference numerals.

Referring to FIGS. 6(A) and 7, telescoping cap 230 includes an open end 232 defining an opening 233, an accordion-like side wall 235, and a closed end 236 including a cover plate 239. As indicated in FIG. 7, accordion-like side wall 235 can be stretched into a expanded configuration in which open end 232 can be mounted onto front surface 214 of base 210 such that an attaching feature 234A formed by an inside surface of side wall 235 adjacent to open end 232 is connected to first attaching structure 115, and closed end 236 and cover plate 239 are positioned over nipple 120 in a manner similar to that described above.

Referring to FIGS. 6(B) and 8, telescoping cap 230 accordion-like side wall 235 can be also be compressed into a collapsed configuration and open end 232 mounted onto rear surface 217 of base 210 such that a second attaching feature 234B formed on an inside surface of side wall 235 adjacent to closed end 236 is connected to second attaching structure 218 in a manner similar to that described above.

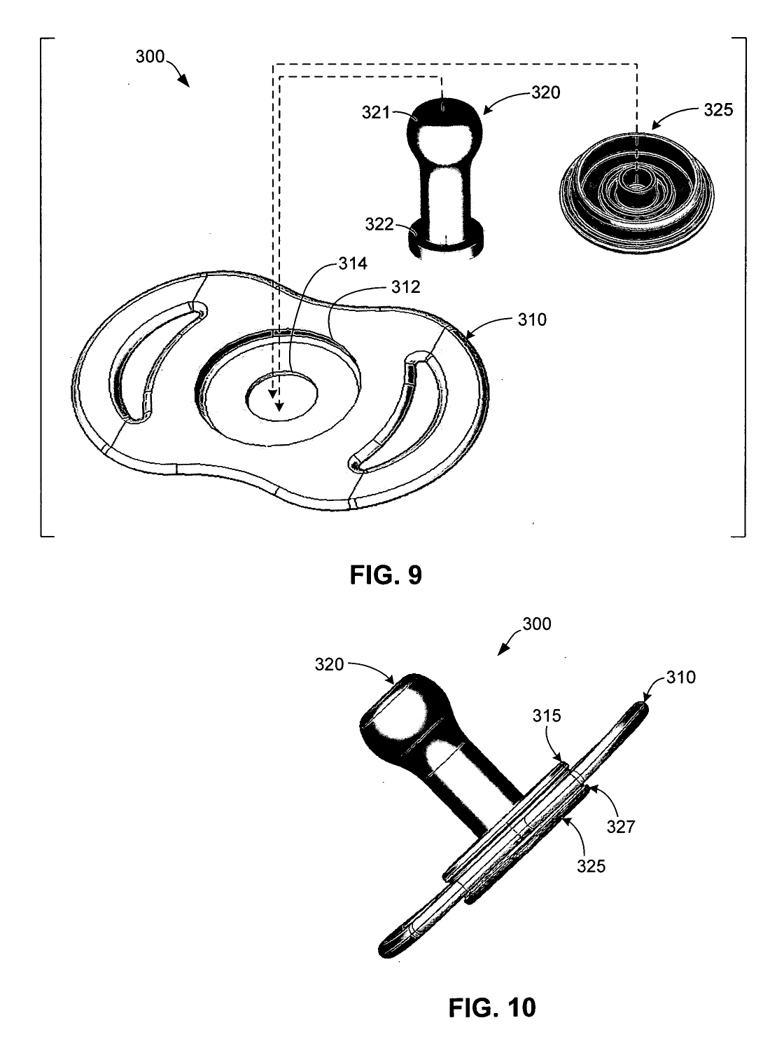

FIGS. 9 and 10 are exploded and assembled perspective views showing a baby pacifier 300 according to another exemplary embodiment of the present invention. Baby pacifier 300 generally includes a substantially flat base 310, an elongated nipple 320, and a locking cover 325. A rear surface of flat base 310 defines a circular recession 312, which in turn defines a nipple opening 314. As indicated by the dashed-line arrows in FIG. 9, a tip end 321 of nipple 320 is inserted through nipple opening 314 (nipple base 322 is wider than opening 314, and thus prevents nipple 320 from passing entirely through base 310), and then locking cover 325 is press-fit into recess 312 to hold nipple 320 in place. As indicated in FIG. 10, a front side of flat base 310 includes a front attaching structure 315, and locking cover 325 includes a rear attaching structure 327.

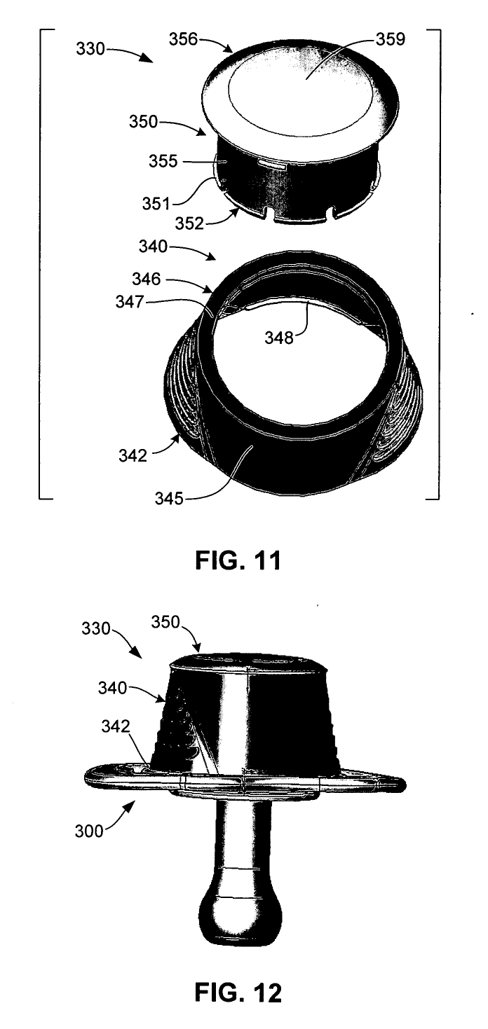

Referring to FIGS. 11 and 12, telescoping cap 330 includes a conical (first) member 340 and a hat- or bowl-shaped (second) member 350 that is slidably received inside conical member 340 in a manner similar to that of telescoping cap 130 (described above). Conical member 340 has a relatively wide (first) end 342 defining a first opening, a conical peripheral wall 345, and a relatively narrow (second) end 346 including a collar 347 defining a second opening. An engaging rib 348 is formed on an inside surface of peripheral wall 345 adjacent first end 342 for alternatively attaching telescoping cap 330 to front attaching structure 315 and rear attaching structure 327 (shown in FIG. 10). Hat-shaped member 350 includes a substantially disk-like or ring-like flange 351 located at a lower (first) end 352 that defines a lower opening, a substantially cylindrical peripheral wall 355, and an upper (second) end 356 that is closed by a cover plate 359. When assembled and mounted onto the rear side of nipple 300, as shown in FIG. 12, telescoping cap 330 is secured in a collapsed position by way of a locking tooth 358 (shown in FIG. 11), which engages a corresponding structure (not shown) formed on collar 347 of conical member 340. Conversely, when mounted onto the front side of nipple 300 (not shown), telescoping cap 330 is secured in an expanded position in a manner similar to that described above.

Although the present invention has been described with respect to certain specific embodiments, it will be clear to those skilled in the art that the inventive features of the present invention are applicable to other embodiments as well, all of which are intended to fall within the scope of the present invention. For example, the attachment structures/features disclosed in the exemplary embodiments may be replaced with suitable alternative structures. In particular, the accordion-like side wall of telescoping cap 230 may be fabricated to be biased into the collapsed configuration, and a single attachment feature provided adjacent to the open end that attaches to both the front-side and rear side attaching features.

1. A baby pacifier comprising:
a base defining opposing first and second surfaces, a first attaching structure formed on the first surface, and a second attaching structure formed on the second surface;
an elongated nipple having a fixed end fixedly connected to the base, the nipple also having a free end extending away from the base; and
a telescoping cap including an open end, a closed end, and at least one attaching feature,
wherein the telescoping cap also includes at least one side wall that is adjustable between:
an expanded configuration in which the open end can be mounted onto the front surface of the base such that the at least one attaching feature is connected to the first attaching structure, and the closed end is positioned over the free end of the nipple, and
a collapsed configuration in which the open end can mounted onto the rear surface of the base such that the at least one attaching feature is connected to the second attaching structure.

2. The baby pacifier of claim 1, wherein the base is substantially flat and includes peripheral side edges, and wherein the base further comprises at least one side handle formed on at least one of the side edges.

3. The baby pacifier of claim 1, wherein the first attaching structure comprises a disk-shaped protrusion extending from the first surface of the base, and wherein the at least one attaching feature includes a first attaching feature comprising an inside edge of the open end of the telescoping cap.

4. The baby pacifier of claim 3, wherein the disk-shaped protrusion comprises a plurality of radial grooves extending parallel to the first surface of the base.

5. The baby pacifier of claim 3, wherein the second attaching structure comprises a threaded, disk-shaped protrusion extending from the second surface of the base, and wherein the at least one attaching feature includes a second attaching feature comprising a threaded structure located on an inside surface of the telescoping cap adjacent to the closed end.

6. The baby pacifier of claim 1, wherein the telescoping cap comprises:
a first member having a relatively wide first end defining a first opening, a first peripheral wall, and a relatively narrow second end defining a second opening; and
a second member including a first end defining a third opening, a second peripheral wall, and a second end including a cover plate,
wherein the second member is slidably received inside the first member such that the first and second peripheral walls form the at least one adjustable side wall of the telescoping cap.

7. The baby pacifier of claim 6,
wherein the first member of the telescoping cap further includes a collar located at the second end, and the second member of the telescoping cap further includes a flange located at the first end, and
wherein the flange abuts the collar when the telescoping cap is in the expanded configuration.

8. The baby pacifier of claim 1, wherein the telescoping cap comprises an accordion-like side wall extending between the open end and the closed end.

9. The baby pacifier of claim 1, wherein the nipple includes a substantially flat surface located at the free end, the flat surface being substantially parallel to the first surface of the base.

10. A baby pacifier comprising:
a base defining opposing first and second surfaces;
an elongated nipple having a fixed end connected to the base and a free end extending away from the base;
a telescoping cap including:
a conical first member having a first and a relatively wide end defining a first opening, and a second, relatively narrow end defining a second opening;
a second member slidably received inside the first member, the second member including a first end defining a third opening, and a second end including a cover plate;
first means for attaching the telescoping cap to the first side of the base in an expanded configuration in which the first end of the second member is located adjacent to the second end of the first member and the cover plate is positioned over the free end of the nipple; and
second means for attaching the telescoping cap to the second side of the base in a collapsed configuration in which the first end of the first member is located adjacent to the first end of the second member.

11. The baby pacifier of claim 10, wherein the base is substantially flat and includes peripheral side edges, and wherein the base further comprises at least one side handle formed on at least one of the side edges.

12. The baby pacifier of claim 10, wherein the first means comprises a disk-shaped protrusion extending from the first surface of the base, and a first attaching feature defined by an inside edge of the first end of the first member.

13. The baby pacifier of claim 12, wherein the disk-shaped protrusion comprises a plurality of radial grooves extending parallel to the first surface of the base.

14. The baby pacifier of claim 12, wherein the second means comprises a threaded disk-shaped protrusion extending from the second surface of the base, and a threaded structure located on an inside edge of the first end of the second member.

15. The baby pacifier of claim 10,
wherein the first member of the telescoping cap further includes a collar located at the second end, and the second member of the telescoping cap further includes a flange located at the first end, and
wherein the flange abuts the collar when the telescoping cap is in the expanded configuration.

16. The baby pacifier of claim 10, wherein the nipple includes a substantially flat surface located at the free end, the flat surface being substantially parallel to the first surface of the base.

17. A baby pacifier comprising:
a base defining opposing first and second surfaces, a first attaching structure formed on the first surface, and a second attaching structure formed on the second surface;
an elongated nipple having a fixed end fixedly connected to the base, the nipple also having a free end extending away from the base;
a telescoping cap including:
a substantially cylindrical first member having a first, relatively wide end defining a first opening, a second, relatively narrow end defining a second opening, wherein the first member includes first means for attaching the first member to the first attaching structure; and
a substantially cylindrical second member slidably received inside the first member, the second member including a first, relatively wide end defining a third opening, and a second end including a cover plate, wherein the second member includes second means for attaching the second member to the first attaching structure.

18. The baby pacifier of claim 17,
wherein the first means comprises a first attaching feature defined by an inside edge of the first end of the first member, and
wherein the second means comprises a threaded structure located on an inside edge of the first end of the second member.

19. The baby pacifier of claim 18, wherein the disk-shaped protrusion comprises a plurality of radial grooves extending parallel to the first surface of the base.

20. The baby pacifier of claim 17,
wherein the first member of the telescoping cap further includes a collar located at the second end, and the second member of the telescoping cap further includes a flange located at the first end, and
wherein the flange abuts the collar when the first member is attached to the first attaching structure.
